(19) United States
(12) Patent Application Publication
(10) Pub. No.: US 2009/0272590 A1
(43) Pub. Date: Nov. 5, 2009

(54) HYDROGEN STORAGE SYSTEM FOR VEHICLE

(75) Inventors: Hyung Ki Kim, Seoul (KR); Sang Hyun Kim, Gyeonggi-do (KR); Hoon Hee Lee, Seoul (KR); Hee Yeon Ryu, Gyeonggi-do (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); KIA MOTORS CORPORATION, Seoul (KR)

(21) Appl. No.: 12/268,117

(22) Filed: Nov. 10, 2008

(30) Foreign Application Priority Data
Apr. 30, 2008 (KR) 10-2008-0040238

(51) Int. Cl. B60K 15/063

(52) U.S. Cl. 180/69.5

(57) ABSTRACT

The present invention provides a hydrogen storage system for a vehicle which is readily attachable to and detachable from the vehicle. The hydrogen storage system includes a plurality of hydrogen tanks filled with hydrogen at the outside and is mounted on the top of a rear underfloor of the vehicle in the form of a cartridge.

For this purpose, the present invention provides a hydrogen storage system for a vehicle, including a hydrogen storage housing, accommodating a hydrogen storage material filled with hydrogen at the outside and easily attached to and detached from the vehicle using a quick connector.

### CROSS-REFERENCE TO RELATED APPLICATION

This application claims under 35 U.S.C. §119(a) the benefit of Korean Patent Application No. 10-2008-0040238 filed Apr. 30, 2008, the entire contents of which are incorporated herein by reference.

### BACKGROUND

(a) Technical Field

The present invention relates to a hydrogen storage system for a vehicle. More particularly, the present invention relates to a hydrogen storage system for a vehicle, which is readily attachable to and detachable from the vehicle.

(b) Background Art

Generally, hydrogen storage methods can include liquid hydrogen storage, high pressure compression, and hydrogen storage using a hydrogen storage material such as metal hydride, porous nanomaterial, etc.

Among commonly used hydrogen storage methods is high pressure compression. Hydrogen storage using a hydrogen storage material has also been intensively studied.

In a hydrogen supply system using high pressure compression, hydrogen supplied from a hydrogen fueling station is filled in a high pressure hydrogen tank, and the hydrogen stored in the high pressure hydrogen tank is supplied to a fuel cell stack, if necessary, after the pressure of the hydrogen is regulated by a high pressure regulator and a low pressure regulator.

Accordingly, a solenoid valve is provided at one end of the high pressure hydrogen tank and an end plug is mounted at the other end such that the hydrogen is filled in the high pressure hydrogen tank through the solenoid valve, which is turned on and off by receiving an operation signal.

As exemplified in FIGS. 3 and 4, a conventional hydrogen storage system for a fuel cell vehicle preferably includes a plurality of high pressure hydrogen tanks 100 capable of being refilled and is suitably mounted on the bottom of an underfloor 101.

Thus, since the high pressure hydrogen tanks 100 being mounted on the bottom of the vehicle are filled with hydrogen, it is unnecessary to detach and reattach the high pressure hydrogen tanks 100 during hydrogen filling. Instead, during system repair, the vehicle is lifted and the hydrogen tanks are detached from the vehicle, if necessary. Reference numeral 102 denotes a tire.

Due to the structure in which the high pressure hydrogen tanks are mounted on the bottom of the underfloor, it not easy to detach and reattach the hydrogen tanks.

Moreover, the high pressure hydrogen tanks mounted on the bottom of the underfloor have the following requirements. A plurality of fastening means such as bolts is required to fix the hydrogen tanks to the vehicle, and the fastening means have to be unfastened and refastened during detachment and reattachment. If the number of the high pressure hydrogen tanks is increased, the time required to unfasten and refasten the fastening means is increased, and thus the process is made more complicated.

Furthermore, since the high pressure hydrogen tanks are mounted on the bottom of the vehicle, the vehicle needs to be lifted to a predetermined height from the ground during detachment and reattachment. Accordingly, additional equipment for lifting the vehicle is required.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

In one aspect, the present invention is directed to a hydrogen storage system for a vehicle, which can preferably be filled with hydrogen at the outside and installed in the form of a cartridge on the top of a rear underfloor of the vehicle, thus facilitating detachment and reattachment.

In one embodiment, the present invention provides a hydrogen storage system for a vehicle, comprising a hydrogen storage housing, accommodating a hydrogen storage material filled with hydrogen at the outside and easily attached to and detached from the vehicle using a quick connector.

In a preferred embodiment, the hydrogen storage material is a plurality of hydrogen tanks connected through a pipe and a connection device.

In another preferred embodiment, the plurality of hydrogen tanks is arranged in the vertical or horizontal direction or stacked in a multilayer in the inside of the hydrogen storage housing.

In still another preferred embodiment, the hydrogen storage housing is installed on the top of a rear underfloor.

In yet another preferred embodiment, the hydrogen storage housing comprises a regulator for supplying hydrogen at a constant pressure stored in the hydrogen tanks to the outside.

In still yet another preferred embodiment, the hydrogen storage housing is readily attachable to and detachable from the rear underfloor through a trunk room.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given herein below by way of illustration only, and thus are not limitative of the present invention, and wherein:

FIG. 1 is a schematic diagram showing a hydrogen storage system for a vehicle in accordance with a preferred embodiment of the present invention.

FIG. 2 is a schematic diagram showing the hydrogen storage system of FIG. 1 mounted on the vehicle.

FIG. 3 is a bottom view showing a conventional hydrogen storage system mounted on the bottom of a vehicle.

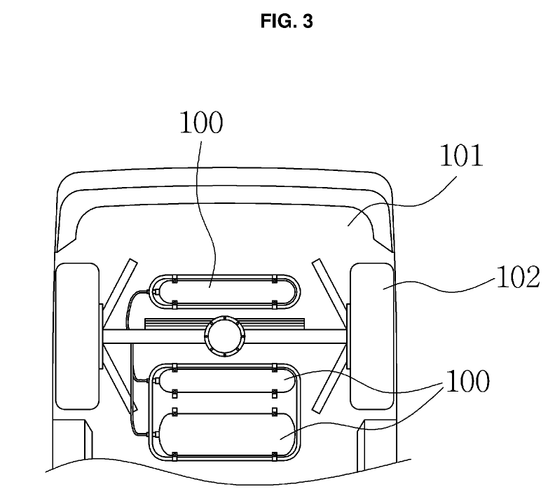

FIG. 4 is a side view of FIG. 3.

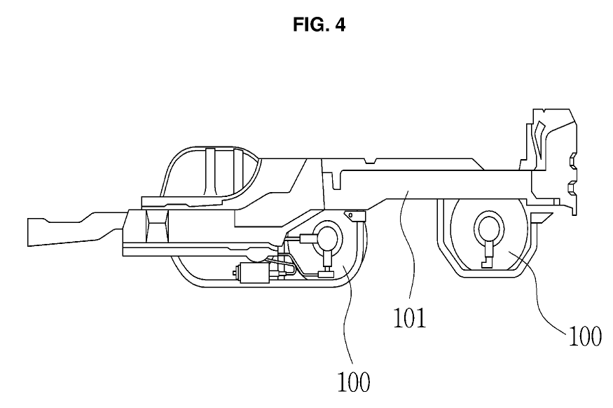

Reference numerals set forth in the Drawings includes reference to the following elements as further discussed below:

| | |
|---|---|
| 10: hydrogen tank | 11: housing |
| 12: handle | 13: rear underfloor |
| 14: regulator | 15: hydrogen sensor |
| 16: quick connector | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

As described herein, the present invention features a hydrogen storage system for a vehicle, comprising a hydrogen storage housing that is easily attached to and detached from the vehicle using a quick connector. In one embodiment of the invention, the hydrogen storage housing accommodates a hydrogen storage material filled with hydrogen at the outside. In another embodiment, the hydrogen storage material is a plurality of hydrogen tanks connected through a pipe and a connection device.

The invention also features a motor vehicle comprising the hydrogen storage system as described herein.

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

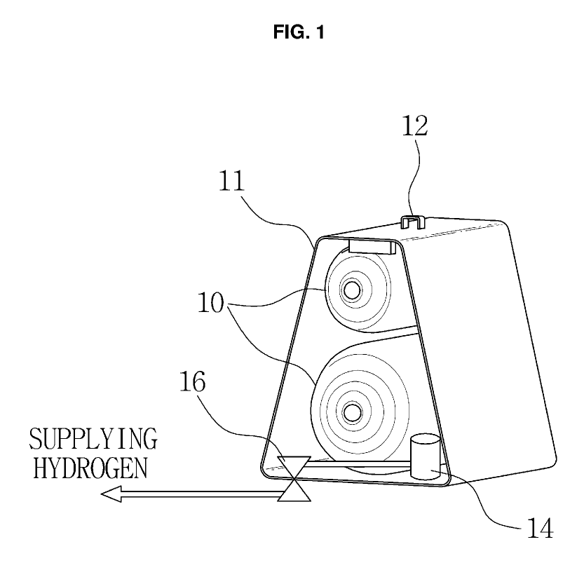

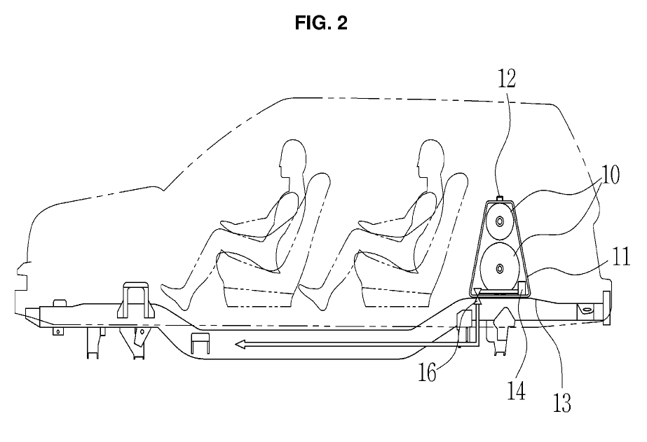

FIG. 1 is a schematic diagram showing an exemplary hydrogen storage system for a vehicle in accordance with a preferred embodiment of the present invention, and FIG. 2 is a schematic diagram showing the hydrogen storage system of FIG. 1 suitably mounted on the vehicle.

According to one preferred embodiment of the present invention, the hydrogen storage system, i.e., a plurality of hydrogen tanks 10, is preferably provided at the rear of the vehicle, instead of the bottom, in order to overcome some of the conventional drawbacks.

In preferred embodiments, where the hydrogen tanks 10 are preferably provided at the bottom of the vehicle in the same manner as the conventional system, there are drawbacks in that the vehicle needs to be lifted to a suitably predetermined height by a lifting device in order to refill hydrogen into the hydrogen tanks 10 and the hydrogen tanks 10 need to be suitably fixed by fastening means.

Accordingly, the present invention preferably provides the hydrogen storage system which is suitably disposed at any preferred position other than the bottom of the vehicle to avoid difficulties in lifting the vehicle, and difficulties in unfastening and refastening a plurality of bolts.

In one embodiment, the hydrogen storage system (or a hydrogen storage material) having a predetermined storage volume in the vehicle, i.e., the plurality of hydrogen tanks 10, is suitably filled or refilled with hydrogen at the outside of the vehicle.

The plurality of hydrogen tanks 10 filled with hydrogen at the outside of the vehicle is easily reattached to the rear of the vehicle.

In further exemplary embodiments, the hydrogen storage system in accordance with a preferred embodiment of the present invention, which is easily attached to and detached from the vehicle, preferably includes a suitably box-shaped housing 11, a plurality of hydrogen tanks 10 suitably provided in the housing 11, a regulator 14 for suitably maintaining the pressure of the hydrogen tanks 10 constant, a valve for supplying the hydrogen at a constant pressure regulated by the regulator 14, and a quick connector 16 provided to suitably facilitate detachment and reattachment of the housing 11 including the hydrogen tanks 10.

Preferably, the structure of the box-shaped housing 11 is not limited to a specific one, and the box-shaped housing 11 may suitably have a space capable of accommodating at least one hydrogen tank 10 and a closed structure to facilitate the transport of the hydrogen tanks 10. In this case, one side of the housing 11 may be suitably opened to facilitate the installation of the hydrogen tanks 10 in the housing 11.

In other preferred embodiments, a handle 12 is provided on the top surface of the box-shaped housing 11 to suitably facilitate the transport of the hydrogen storage system in accordance with a preferred embodiment of the present invention.

In other embodiments, each of the hydrogen tanks 10 may be in the form of a bomb, which is suitably a combination of a cylindrical shape and a hemispherical shape, or may have any other suitable form. Moreover, in certain preferred embodiments, the form of the hydrogen tank 10 can be suitably modified according to the demands of users. In other preferred embodiments, the hydrogen tank 10 includes an inlet for filling hydrogen and a connection device for connection between the tanks 10.

In exemplary embodiments, the hydrogen tanks 10 are suitably connected by a pipe (not shown) so as to suitably discharge hydrogen to the outside of the housing 11 through the pipe at a constant pressure. Preferably, a hydrogen sensor for detecting the internal pressure of the hydrogen tank 10 may be suitably mounted on each of the hydrogen tanks 10. In certain embodiments, the present invention may be suitably employed in a chemical hydrogen storing system, in which a hydrogen tank stores hydrogen by an irreversible reaction.

In other preferred embodiments, the regulator 14 is provided in the housing 11 to constantly regulate the pressure of the hydrogen tank 10, and the hydrogen at a constant pressure regulated by the regulator 14 is suitably discharged to the outside of the housing 11. Moreover, the regulator 14 connected to the pipe is preferably provided at the bottom of the housing 11.

In other preferred embodiments, the quick connector 16 is provided on the bottom of the housing 11 so as to suitably mount the hydrogen storage system on the top of a rear underfloor 13. Since the quick connector 16 is a commercially available component, with which a user can manually replace the hydrogen storage system with a new one, its detailed description will be omitted.

In exemplary embodiments, the rear underfloor 13 designates a rear portion of a third seat in a recreational vehicle (RV) or sport utility vehicle (SUV), and the housing 11 mounted on the rear underfloor 13 can be suitably replaced through a trunk room.

According to other embodiments, the housing 11 including the hydrogen tanks 10 can be easily detached from and reattached to the rear underfloor 13 by manually disconnecting and connecting the quick connector 16 suitably provided on the top of the rear underfloor 13.

In other embodiments, since the hydrogen tanks 10 are suitably arranged in parallel in the inside of the housing 11 and fitted by the pipe and the connection device, they can be used until hydrogen stored in the last hydrogen tank 10 is all discharged to the outside. Preferably, when the hydrogen in the hydrogen tanks 10 is all used, the housing 11 including the empty hydrogen tanks 10 is preferably replaced with a new housing 11 including hydrogen tanks 10 filled with hydrogen at the outside.

As described above, according to the hydrogen storage system of the present invention, since the hydrogen storage system suitably including a plurality of hydrogen tanks filled with hydrogen at the outside can be readily mounted on the vehicle in the form of a cartridge, it is possible to increase the hydrogen storage density per volume and suitably ensure a space for a spare tire on the bottom of the vehicle.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A hydrogen storage system for a vehicle, comprising a hydrogen storage housing, accommodating a hydrogen storage material filled with hydrogen at the outside and easily attached to and detached from the vehicle using a quick connector.

2. The hydrogen storage system for a vehicle of claim 1, wherein the hydrogen storage material is a plurality of hydrogen tanks connected through a pipe and a connection device.

3. The hydrogen storage system for a vehicle of claim 2, wherein the plurality of hydrogen tanks is arranged in the vertical or horizontal direction or stacked in a multilayer in the inside of the hydrogen storage housing.

4. The hydrogen storage system for a vehicle of claim 3, wherein the hydrogen storage housing is installed on the top of a rear underfloor.

5. The hydrogen storage system for a vehicle of claim 4, wherein the hydrogen storage housing comprises a regulator for supplying hydrogen at a constant pressure stored in the hydrogen tanks to the outside.

6. The hydrogen storage system for a vehicle of claim 1, wherein the hydrogen storage housing is readily attachable to and detachable from the rear underfloor through a trunk room.

7. A hydrogen storage system for a vehicle, comprising a hydrogen storage housing that is easily attached to and detached from the vehicle using a quick connector.

8. The hydrogen storage system for a vehicle of claim 7, wherein the hydrogen storage housing accommodates a hydrogen storage material filled with hydrogen at the outside.

9. The hydrogen storage system for a vehicle of claim 8, wherein the hydrogen storage material is a plurality of hydrogen tanks connected through a pipe and a connection device.

10. A motor vehicle comprising the hydrogen storage system of claim 1.

11. A motor vehicle comprising the hydrogen storage system of claim 7.
